(19) United States
(12) Patent Application Publication
(10) Pub. No.: US 2008/0010363 A1
(43) Pub. Date: Jan. 10, 2008

(54) Communication apparatus and communication method

(75) Inventor: Hiroaki Kobayashi, Yokohama-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/806,968

(22) Filed: Jun. 5, 2007

(30) Foreign Application Priority Data
Jun. 22, 2006 (JP) 2006-172899

(51) Int. Cl. G06F 15/16; G06F 17/30

(52) U.S. Cl. 709/219

(57) ABSTRACT

According to one embodiment, there is provided a communication apparatus including a communication section which collects list information about contents data from a plurality of server devices on a network, a display section which displays the list information about the contents data collected by the communication section together with performance information about the plurality of server devices for storing the contents data therein, an operating section which outputs operation signals for specifying one contents data in the list information and one server device, and a control section which acquires the specified contents data from the specified server via the communication section according to the operation signals.

### CROSS-REFERENCE TO RELATED APPLICATIONS

This application is based upon and claims the benefit of priority from Japanese Patent Application No. 2006-172899, filed Jul. 22, 2006, the entire contents of which are incorporated herein by reference.

### BACKGROUND

1. Field

One embodiment of the invention relates to a communication apparatus and a communication method for communicating with another communication apparatus via a network.

2. Description of the Related Art

In recent years, the digital network technique is generally coming into wide use, and a lot of communication apparatuses which use this technique are developed. In such a network communication environment, a technique which moves contents on a network is also known.

In connection with this technique, Patent Document 1 (Jpn. Pat. Appln. KOKAI Publication No. 2005-525611) discloses a technique for receiving contents from a plurality of servers via a network.

The conventional technique of Patent Document 1, however, does not display device information about a plurality of servers for a user. Therefore, the user cannot select one server from the plurality of serve to acquire contents data in an optimum communication condition.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a system diagram illustrating a communication system according to one embodiment of the present invention;

FIG. 2 is an appearance diagram illustrating one example of a player according to one embodiment of the present invention;

FIG. 3 is a block diagram illustrating one example of an electric configuration of the player according to one embodiment of the present invention;

FIG. 4 is a block diagram illustrating one example of an electric configuration of a server device according to one embodiment of the present invention;

FIG. 5 is an explanatory diagram illustrating one example of a contents list displayed by the player according to one embodiment of the present invention;

FIG. 6 is an explanatory diagram illustrating one example of a contents list of each server device displayed by the player according to one embodiment of the present invention;

FIG. 7 is an explanatory diagram illustrating one example of a performance information list of the plurality of server devices displayed by the player according to one embodiment of the present invention;

FIG. 8 is a flowchart illustrating one example of contents data acquiring process of the player according to one embodiment of the present invention;

FIG. 9 is a flowchart illustrating one example of the contents data acquiring process based on a communication condition of the player according to one embodiment of the present invention; and

FIG. 10 is an explanatory diagram illustrating another example of the contents data acquiring process based on the communication condition of the player according to one embodiment of the present invention.

### DETAILED DESCRIPTION

Various embodiments according to the invention will be described hereinafter with reference to the accompanying drawings. In general, according to one embodiment of the invention, a communication apparatus comprising: a communication section which collects list information about contents data from a plurality of server devices on a network; a display section which displays the list information about the contents data collected by the communication section together with performance information about said plurality of server devices for storing the contents data therein; an operating section which outputs operation signals for specifying one contents data in the list information and one server device; and a control section which acquires the specified contents data from the specified server via the communication section according to the operation signals.

One embodiment of the present invention provides a communication apparatus and a communication method for selecting a suitable server from a plurality of servers so as to acquire contents data.

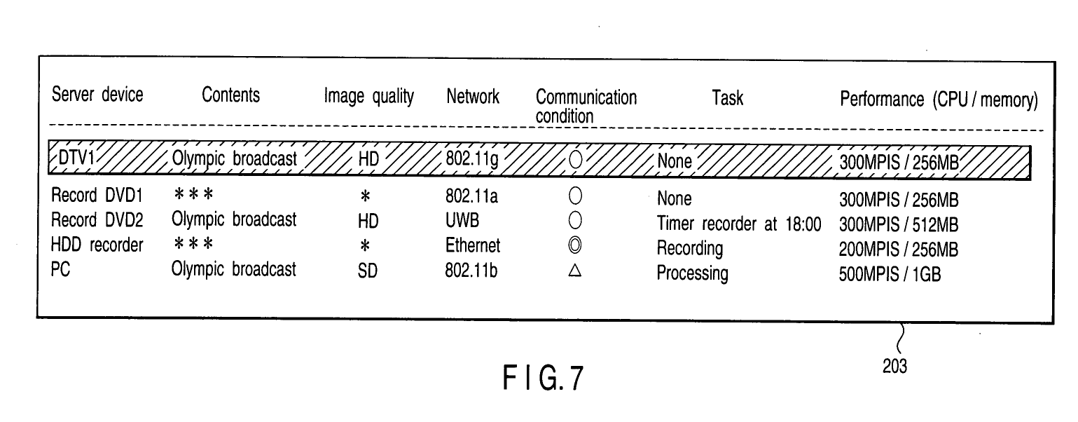

One embodiment of the present invention provides a communication apparatus (2) comprising: a communication (11) section which collects list information (FIGS. 6, 7) about contents data from a plurality of server devices (100-1, 100-2) on a network; a display section (6) which displays the list information about the contents data collected by the communication section together with performance information about said plurality of server devices for storing the contents data therein; an operating section (7) which outputs operation signals for specifying one contents data in the list information and one server device; and a control section (22) which acquires the specified contents data from the specified server via the communication section according to the operation signals.

As a result, an optimum server on the network is selected so that contents data can be acquired in a satisfactory communication condition.

An embodiment of the present invention will be described in detail below with reference to drawings.

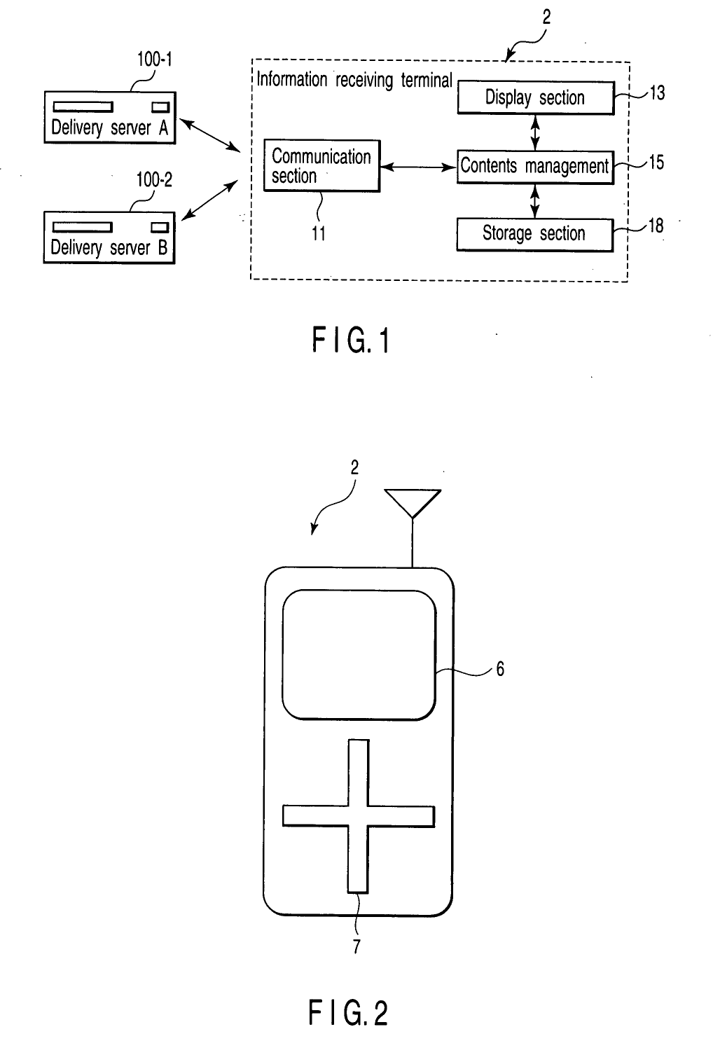

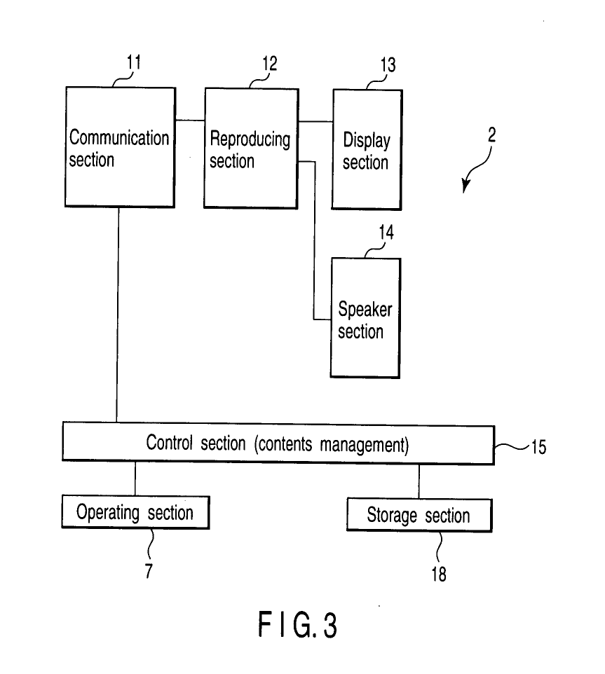

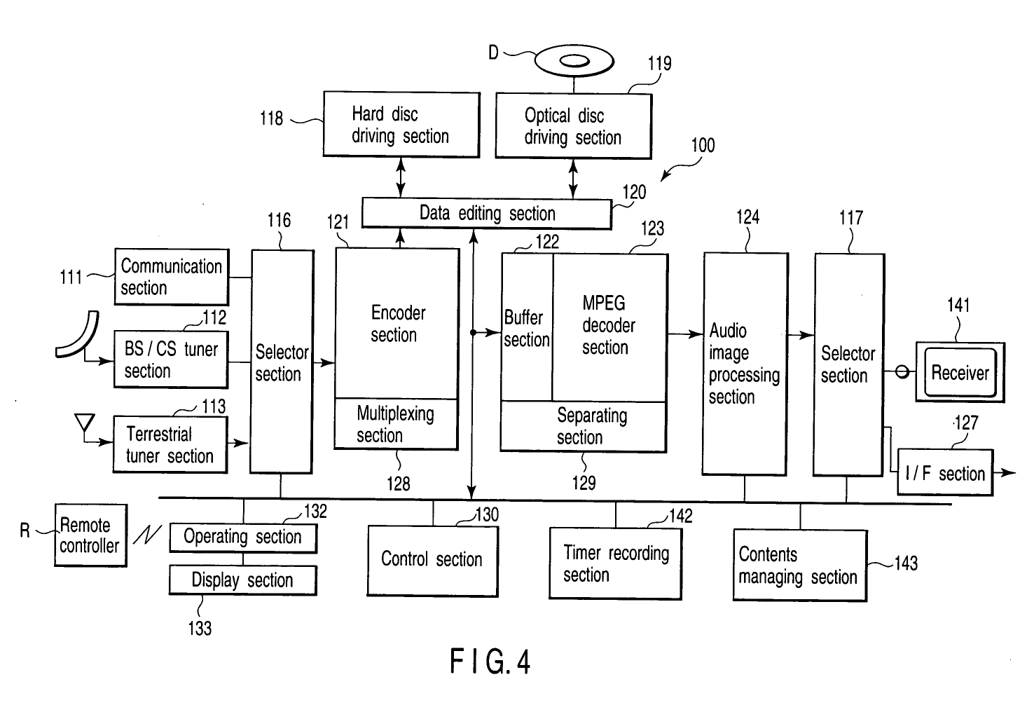

FIG. 1 is a system diagram illustrating one example of a communication system according to one embodiment of the present invention. FIG. 2 is an appearance diagram illustrating one example of a player. FIG. 3 is a block diagram illustrating one example of an electric configuration of the player. FIG. 4 is a block diagram illustrating one example of an electric configuration of a server device.

A player which reproduces contents data, for example, is described as the communication apparatus which acquires contents data, and a hard disc recorder is described as the server device for providing contents data.

<Communication System According to One Embodiment of the Present Invention>

A communication system according to one embodiment of the present invention has, as shown in FIG. 1, a player device 2 having a communication function and a contents reproducing function, and server devices 100-1 and 100-2 such as hard disc recorders having a contents recording/reproducing function.

(Constitution and Operation of the Player Device)

The constitution of the player device 2 will be described with reference to FIGS. 2 and 3. The player device 2 according to this embodiment has a communication section 11, a reproducing section 12, a display section 13, a speaker section 14, and a control section 15. The communication section 11 communicates by means of, for example, radio LAN standard 801.11a, UWB (Ultra Wide Band), Ethernet®, Bluetooth® or the like. The reproducing section 12 reproduces moving image contents data or audio contents data by means of the coding system such as MPEG (Moving Picture Experts Group), SBC (Sub Band Codec), MP3 (MPEG audio Layer-3) or the like. The display section 13 displays contents data such as moving image contents. The speaker section 14 reproduces audio contents data. The control section 15 controls an entire operation and manages contents in such a manner that contents data are transmitted. The player device 2 has an operating section 7 such as an arrow key for making a user perform various operations of the player device, and a display section 6 which displays contents data such as moving images and operating information such as a contents list.

The player device 2 receives operation signals from the operating section 7 via the control section 15 according to the user's operations. Under the control of the control section 15, the reproducing section 12 decodes contents data such as music data and moving image data acquired via the communication section 11. The player device reproduces a moving image or the like as contents data on the display section 13 such as a liquid crystal screen.

(Constitution and Operation of Hard Disc Recorder as Server Device)

On the other hand, the constitution and the operation of the hard disc recorder as one example of the server device will be described below.

FIG. 4 is a block diagram illustrating one example of the constitution of the hard disc recorder as one example of the server device according to one embodiment of the present invention. A hard disc recorder 100 in FIG. 4 has two types of disc driving sections. One of them is an optical disc driving section 119 which drives to rotate an optical disc D as a first medium which is an information recording medium where video files can be structured, and reads/writes information. The other one is a hard disc driving section 118 which drives a hard disc as a second medium. A control section 130 is connected to the respective sections via a data bus so as to control the entire operation.

The hard disc recorder 100 in FIG. 4 includes an encoder section 121 which structures a recording side, an MPEG decoder section 123 which structures a reproducing side and the control section 130 which controls the operation of the apparatus main body as main components. The hard disc recorder 100 has an input-side selector 16 and an output-side selector 17. The input-side selector 16 is connected to a communication section 111 such as LAN, a so-called satellite broadcasting (BS/CS) tuner section 112, and a so-called terrestrial tuner section 113. A signal is output to the encoder section 121. The BS/CS tuner section 112 is connected to a satellite antenna, and the terrestrial tuner section 113 is connected to a terrestrial antenna. The hard disc recorder 100 has the encoder section 121, a data editing section 120, the hard disc driving section 118 and the optical disc driving section 119. The data editing section 120 receives an output from the encoder section 121 and executes a desired data process such as data editing. The hard disc driving section 118 and the optical disc driving section 119 are connected to the data editing section 120.

The hard disc recorder 100 has an MPEG decoder section 123, the encoder section 121, a buffer section 122, a multiplexing section 128, a separating section 129, the control section 130, a timer recording section 142, the player device, mentioned later, and a contents managing section 143. The MPEG decoder section 123 receives signals from the hard disc driving section 118 and the optical disc driving section 119 so as to execute decoding. The contents managing section 143 manages a transmitting process of contents data, and transmission of contents list and a performance information list. The respective sections are connected to the control section 130 via a data bus. An output from a selector section 117 is connected to an external receiver 141 or is supplied to an external device via an interface section 127 which executes communication with the external device.

The hard disc recorder 100 has an operating section 132 which is connected to the control section 130 via the data bus and is operated by a user's operation or an operation using a remote controller R. The remote controller R enables an operation which is approximately equivalent to that of the operating section 132 provided to the main body of the hard disc recorder 100. The remote controller R can instruct recording/reproducing to/from the hard disc driving section 118 and the optical disc driving section 119, instruct editing, or can set various items such as tuner operation and timer recording.

The outline of a reproducing process and a recording process for an optical disc, for example, in the hard disc recorder 100 having such a constitution will be described. Under the control of the control section 130, a laser beam is emitted to an optical disc D which is rotated at a predetermined speed, and its reflection light is detected by an optical pickup. A detection signal based on the detection is output. An RF signal is generated based on the detection signal, and the reproducing process is executed after the data reading process.

At the optical disc recording process, under the control of the control section 130, data supplied via an input section, not shown, and the selector section 116 are supplied to the encoder section 121 and are coded to be output. A driving current of a laser driver is supplied to the optical pickup according to the coded output and the output from the control section 130. A laser beam is emitted to a storage region of the optical disc D so that the recording process is executed.

In the hard disc recorder 100, contents data as program information is supplied by the BS/CS tuner section 112 and the terrestrial tuner section 113 according to timer recording information set by the timer recording section 142. The contents data is encoded by the encoder section 121 so as to be stored in the hard disc driving section 118 or the optical disc D. Moving image data as the stored contents data can be transmitted from the communication section 111 to a player device such as an information receiving terminal 2 by a contents acquiring method using the player device.

(Method for Acquiring Contents Data)

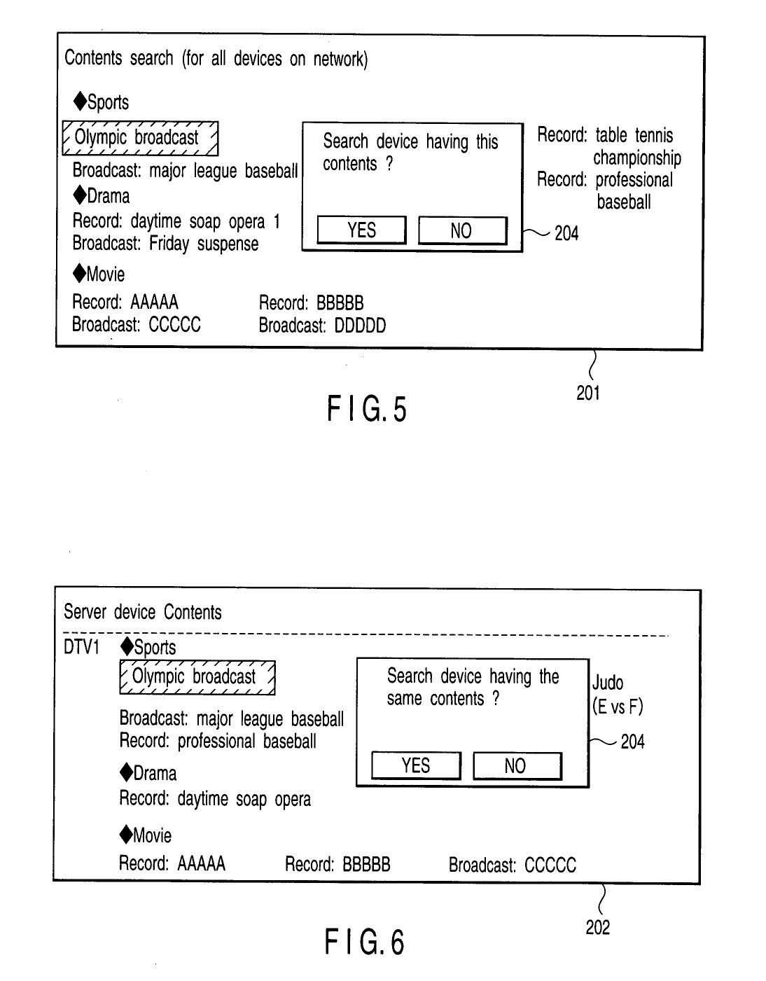

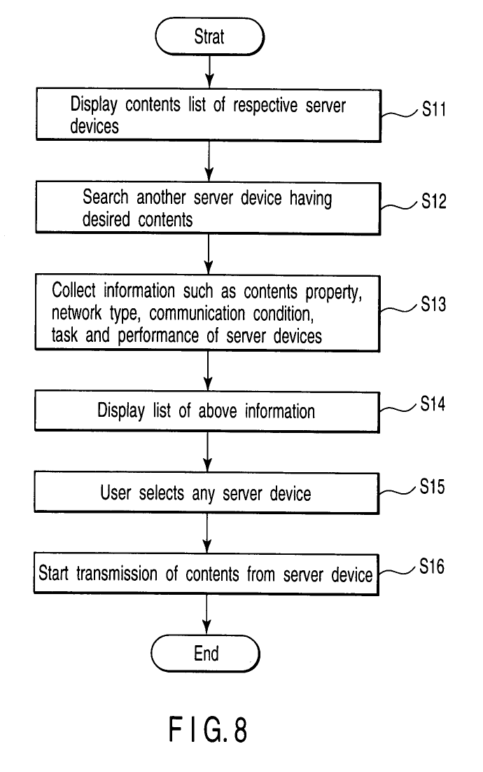

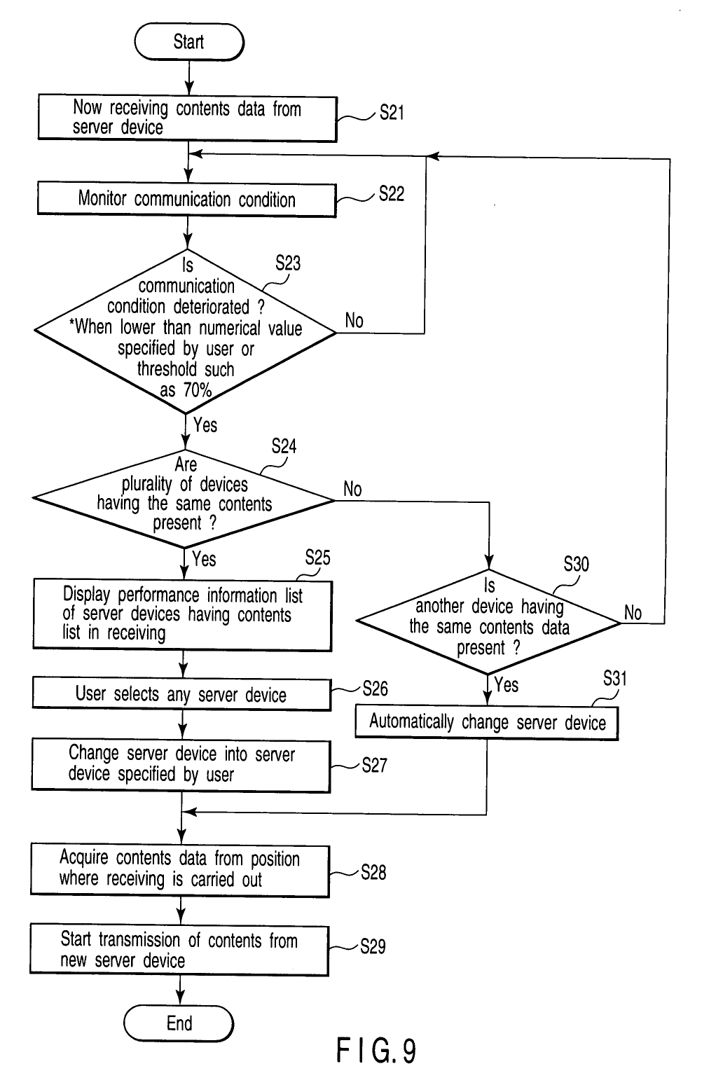

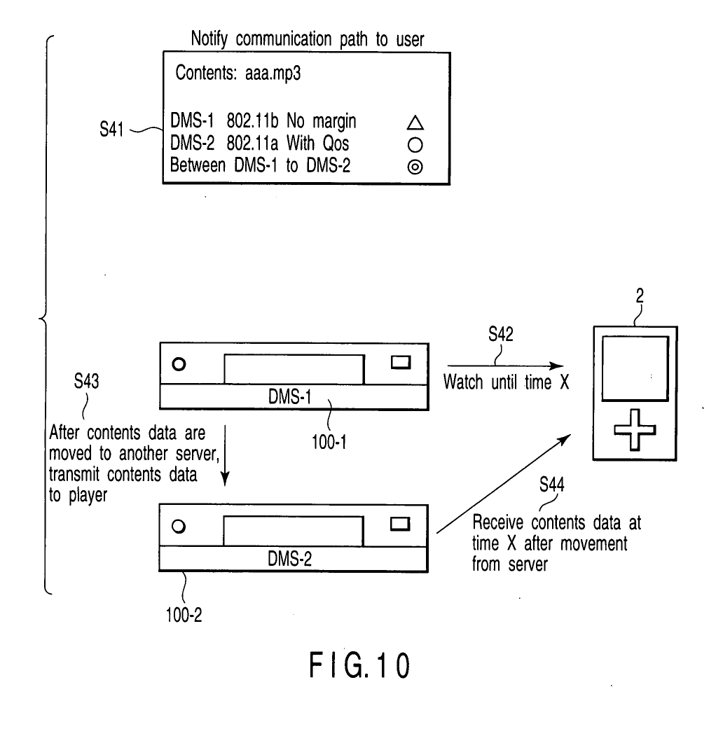

A contents data acquiring method according to one embodiment of the present invention will be described in detail below with reference to drawings. FIG. 5 is an explanatory diagram illustrating one example of a contents list displayed by the player. FIG. 6 is an explanatory diagram illustrating one example of a contents list of each server device displayed by the player. FIG. 7 is an explanatory diagram illustrating one example of a performance information list of the plurality of server devices displayed by the player. FIG. 8 is a flowchart illustrating one example of the contents data acquiring process of the player. FIG. 9 is a flowchart illustrating one example of the contents data acquiring process according to a communication condition of the player. FIG. 10 is an explanatory diagram illustrating another example of the contents data acquiring process according to a communication condition of the player.

Contents Data Acquiring Method

The method of acquiring contents data from the server device on the network by means of the player device will be described below with reference to the flowchart of FIG. 9. The steps of the flowcharts can be replaced by circuit blocks. The step of the flowcharts can be, therefore, redefined by blocks.

The standard of the communication between the player device 2 and the server devices 101-1 and 101-2, mentioned below, preferably conforms to an interface regulation of a home network set up by UPnP (Universal Plug and Play).

The player device 2 acquires list information as contents data management information from the server devices 100-1 and 100-2 on the network via the communication section 11 using the control section (contents managing section) 15 in advance.

The list information desirably includes not only the contents data but also performance information of the server devices in a broad sense, mentioned later. The performance information includes, for example, a network type to be used, the communication condition, an on-processing task, a task scheduled to be processed, communication performance, CPU performance and a capacity of a buffer memory. The performance information can be, however, acquired from the server devices 100-1 and 100-2 at a timing different from that of the list information.

When an operation signal is received from the operating section 7 according to the user's operation, the list information is edited by the control section 15, and a screen of a contents list 201 shown in FIG. 5 is displayed on the display section 13 (step S11).

The contents list 201 of FIG. 5 does not show as to which contents data is stored in which server device, but shows only contents data which can be treated by the player device 2 and is classified according to categories (sports and the like).

The contents list to be displayed may be, however, a contents list 202 of each server as shown in FIG. 6. The contents list 202 in FIG. 6 shows only contents which are treated only by a server device DTV1 in the plurality of server devices.

The contents lists 201 and 202 of the server devices shown in FIGS. 5 and 6 show an instruction icon 204 for asking if another server device on the network is searched for the contents “Olympics broadcast” selected by a user. When the user selects the searching, the list information as the management information of the contents data acquired in advance is searched and a determination is made whether the contents “Olympics broadcast” is present in another server device (step S12).

Performance information about each server device in a broad sense is acquired from the list information as the contents data management information acquired in advance (step S13). The performance information includes, for example, a network type to be used, a communication condition, a on-processing task, a task scheduled to be processed, communication performance, CPU performance and the capacity of the buffer memory. When the performance information is acquired in advance, the number of times of the communication with the server device can be made smaller than the case where the information is acquired many times.

In another manner, the performance information may be acquired not from the list information but by again accessing directly to the server devices 100-1 and 100-2. In this case, the latest conditions of the server devices can be checked.

The performance information about the server devices is displayed as a performance information list 203 of the server devices shown in FIG. 7 on the display section 6 under the control of the contents managing section 15. The performance information list 203 of the server device shown in FIG. 7 includes the performance information of the server device storing the contents data “Olympics broadcast” selected by the user's operation in advance.

As to the performance information, as shown in FIG. 7, “network type to be used” shows 802.11 g, UWB or Ethernet®. The “communication condition” can be determined by comparing a communication speed with a predetermined value and evaluating the speed according to stages. Not only the “on-processing task” but also the “task scheduled to be processed” such as a timer process is displayed, and used for user's judgment. Further, the “CPU performance” and the “the capacity of the buffer memory” are displayed and similarly used for the judgment.

Image qualities of HD and SD and the other information which are not the performance information about the server devices can be displayed as property information about contents data in the performance information list 203 of the server device.

The user refers to the performance information list 203 of FIG. 7 on the display section 6 and simultaneously selects the optimum one of the server devices using the operating section 7 (step S15). The player device 2 receives the operation signal by means of the control section 15, and starts communication in order to acquire contents data specified by the specified server device using the communication section 11 (step S16).

With this method, the optimum server device on the network can be selected by user's comprehensive judgment. For this reason, contents data can be securely transmitted from the server device according to the condition.

Server Device Changing Method

The server device changing method in the case where the communication condition is changed during the contents data acquiring process will be described in detail below with reference to a flowchart of FIG. 9 and an explanatory diagram of FIG. 10. The steps of the following flowcharts can be replaced by circuit blocks, and thus the steps of the flowcharts can be redefined by blocks.

When the player device 2 receives contents data from the specified server device 100-1 (step S21), the contents managing section 15 monitors the communication condition between the player device 2 and the server device 10-1 (step S22). The contents managing section 15 can also monitor communication condition between the server device 100-1 and another server device 100-2 and the communication condition between the player device 2 and another server device 100-2.

The contents managing section 15 determines whether the communication condition between the player device 2 and the server device 100-1 is deteriorated in comparison with a user's specified value or a threshold such as 70% (step S23). When the contents managing section 15 determines that it is deteriorated, it determines whether a plurality of server devices having the same contents data are present (step S24). When the plurality of server devices having the same contents data are not present, the sequence goes to step S30, and the contents managing section 15 determines whether even one server device having the same contents data is present (step S30).

When the contents managing section 15 determines that no server device having the same contents data is present, the sequence returns to step S22, and the monitoring continues. When the contents managing section 15 determines that only one server device having the same contents data is present at step S30, the communication is automatically switched to that server device, so that the contents data transmitting process continues (step S31).

When the contents managing section 15 determines at step S24 that a plurality of server devices having the same contents data are present, it displays the performance information list of these server devices on the display section 6 (step S25). Accordingly, the user selects any server device specified by the operating section 7 (step S26).

Accordingly, the contents managing section 15 of the player device 2 changes a communication destination into a specified server device (step S27). The transmission of the contents data is started (step S29) in the last position where the contents data are received in order to acquire the contents data from a new server device (step S28).

As a result, even when the communication condition is deteriorated during communication, the communication destination is switched into a server device whose communication condition is satisfactory so that the contents data can be securely acquired.

Movement of Contents Data between Server Devices

As shown in the explanatory diagram of FIG. 10, a server device changing process including the movement of contents data between server devices is enabled. That is to say, at step S22 of FIG. 9, all of the communication condition between the player device 2 and the server device (DMS-1) 100-1, the communication condition between the player device 2 and the server device (DMS-2) 100-2, and the communication condition between the server device (DMS-1) 100-1 and the server device (DMS-2) 100-2 can be recognized (step S41).

Assume that the communication condition between the player device 2 and the server device (DMS-1) 100-1 is deteriorated, the communication condition between the player device 2 and the server device (DMS-2) 100-2 is satisfactory, and the communication condition between the server device (DMS-1) 100-1 and the server device (DMS-2) 100-2 is satisfactory. In this case, the movement of data contents between the server devices is suitable.

That is to say, the server device (DMS-1) 100-1 transmits the contents data until time X (step S42). In order to move the contents data at the time X from the server device (DMS-1) 100-1 to the server device (DMS-2) 100-2, a movement command signal is supplied from the player device 2 to the server device (DMS-1) 100-1 (step S43). The player device 2 communicates with the server device (DMS-2) 100-2, so as to receive the contents data at the time X after the movement from the server device (DMS-2) 100-2 (step S44).

When the player device receives and reproduces contents data simultaneously, the steps S41 to S44 are executed partially simultaneously, so that reproducing interruption of contents data can be avoided.

The movement of contents data between the server devices is further adopted, so that the process for acquiring optimal contents data according to the communication conditions of the system can be executed.

According to the above various embodiments, those skilled in the art can realize the present invention and can easily come up with various modified examples of the embodiments. Those skilled in the art which do not have inventive ability can apply the present invention to various embodiments. The present invention, therefore, covers a wide range which is consistent with the disclosed principle and new characteristics, and is not limited to the above embodiments.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A communication apparatus comprising:
a communication section which collects list information about contents data from a plurality of server devices on a network;
a display section which displays the list information about the contents data collected by the communication section together with performance information about said plurality of server devices for storing the contents data therein;
an operating section which outputs operation signals for specifying one contents data in the list information and one server device; and
a control section which acquires the specified contents data from the specified server via the communication section according to the operation signals.

2. The communication apparatus according to claim 1, wherein the performance information about the server devices includes one or more of a network type to be used, a communication condition, an on-processing task, a task scheduled to be processed, communication performance, CPU performance and a capacity of a buffer memory.

3. The communication apparatus according to claim 1, wherein after the display section displays the list information about the contents data, the operating section outputs the operation signal for specifying one contents data, and after the display section displays said plurality of server devices for storing the specified contents data together with the performance information, the operating section outputs the operation signal for specifying one server device.

4. The communication apparatus according to claim 1, wherein the control section monitors a communication condition with respect to a communicating server device while acquiring the contents data, and when the communication condition is deteriorated, the control section changes the server device into another server device so as to continue acquiring the contents data.

5. The communication apparatus according to claim 1, wherein the control section monitors a communication condition with respect to a communicating server device while acquiring the contents data, and when the communication condition is deteriorated, the control section displays another server device which can acquire the contents data on the display section and changes the server device into another server device according to a given operation signal so as to continue acquiring the contents data.

6. The communication apparatus according to claim 1, wherein the control section monitors communication conditions with respect to a communicating server device and another server device while acquiring the contents data, and when the communication condition with respect to the communicating server device is deteriorated, the control section outputs a command signal to the communicating server device in order to move the contents data from the communicating server device to another server device, so as to acquire the contents data from the another server device.

7. A communication method between a plurality of server devices and a player device via a network, comprising:
collecting list information about contents data from said plurality of server devices on the network using the player device;
displaying the collected list information about the contents data together with performance information about said plurality of server devices which store the contents data therein;
outputting operation signals for specifying one of the contents data in the list information and one server device; and
acquiring the specified contents data from the specified server device according to the operation signals.

8. The communication method according to claim 7, wherein the performance information about the server device includes one or more of a network type to be used, a communication condition, an on-processing task, a task scheduled to be processed, communication performance, CPU performance and a capacity of a buffer memory.

9. The communication method according to claim 7, wherein after the list information about the contents data is displayed, the operation signal for specifying one contents data is output, and after said plurality of server devices which store the specified contents data are displayed therein together with the performance information, the operation signal for specifying one server device is output.

10. The communication method according to claim 7, wherein while the contents data are being acquired, a communication condition with respect to the communicating server device is monitored, and when the communication condition is deteriorated, the server device is changed into another server device so that the acquiring of the contents data is continued.

11. The communication method according to claim 7, wherein while the contents data are being acquired, a communication condition with respect to the communicating server device is monitored, and when the communication condition is deteriorated, another server device which can acquire the contents data is displayed and the server device is changed into another server device so that the acquiring of the contents data is continued.

12. The communication method according to claim 7, wherein while the contents data are being acquired, communication conditions with respect to the communicating server device and another server device are monitored, and when the communication condition with respect to the communicating server device is deteriorated, a command signal is output to the communicating server device in order to move the contents data from the communicating server device to another server device, so that the contents data are acquired from the another server device.
